(19) United States
(12) Patent Application Publication
(10) Pub. No.: US 2009/0171984 A1
(43) Pub. Date: Jul. 2, 2009

(54) APPARATUS AND METHOD FOR INTERLINKING THE CLASSIFIED OBJECTS HAVING THE PROPERTY AND COMPUTER READABLE MEDIUM PROCESSING THE METHOD

(76) Inventors: Deuk Hee Park, Seoul (KR); Boh Yoon Park, Seoul (KR); Hwa Yun Suh, Seoul (KR); Sung Chul Shin, Seoul (KR); Hee Young Ahn, Seoul (KR); Kyoung Su Lee, Seoul (KR); Kyung Sun Jo, Seoul (KR); Yong Ho Hwang, Seoul (KR)

Correspondence Address: RABIN & Berdo, PC, 1101 14TH STREET, NW, SUITE 500, WASHINGTON, DC, 20005, US

(21) Appl. No.: 11/718,166

(22) PCT Filed: Oct. 29, 2005
(86) PCT No.: PCT/KR05/03625

§ 371 Date: Apr. 27, 2007

(30) Foreign Application Priority Data
Oct. 30, 2004 (KR) 10-2004-0087612
Jun. 24, 2005 (KR) 10-2005-0054853

(51) Int. Cl. G06F 17/30; G06F 15/16; G06F 3/00

(52) U.S. Cl. 707/100; 709/202; 715/758; 707/E17.044

(57) ABSTRACT

Disclosed is an apparatus for interlinking topical classified object shaving properties. The apparatus include an interest Tong information database for storing one or more object information and one or more post information, which are classified according to interest fields requested by a user through a web server; a buddy information database for storing information on connection between the objects generated by the user and other objects; and an interest Tong service server for providing the user with information on the other objects connected to the objects generated by the user when the user accesses the interest Tong service server.

### TECHNICAL FIELD

This invention relation relates to a method for interlinking contents between users on web sites, and more particularly to an apparatus and method for interlinking the classified objects having the property and a computer-readable medium for processing the method.

### BACKGROUND ART

In general, a blog, which is a newly-coined word that is a combination of ‘Web’ implying the Internet and ‘logs’ implying a ship's journal, is being understood as a new on-line medium on which columns, diaries, articles and the like are put to form public opinions.

Although the blog seems to be similar to an existing Internet bulletin board in which individuals put their writings, it has a great significance as individual media in that it makes a field of forming a high level of public opinions by continuing to update peculiar contents. Internet bulletin boards of general organs of public opinions and so on have many problems due to anonymity and unidirectionality, but blogs have reinforced contents since they are interlinked between themselves and continue to update their opinions as individual media without writing replies indiscriminately.

On the other hand, the term ‘post’ on web services refers to the unit of bulletin produced by a user. The user classifies posts according to subjects and stores and manages the classified posts on webs using means such the above-mentioned blog.

The classification is called a category, folder or the like, which has only a function of giving names to the posts to distinguish therebetween using subjects, keywords or the like set by the user. However, the posts only allow the user to recognize information on a subject A or information on a subject B, for example, but has a limitation in collecting, storing, managing, extending and so on the information from the point of view of the user.

Particularly, from the point of view of connection between formation for efficient search and management of the information, existing services suggest only a level of bookmark allowing the user to visit categories of a desired web site without difficulty through connection among users or connection between categories and users with a contents owner as the central figure.

On the other hand, selection, acquisition, and connection of information through such blogs are motivated in the course of selecting details or subjects of contents. However, since the connection between the information with the contents owner as the central figure does not reflect the motive for the information selection, when the user again visits the web site to obtain update information, there arises a problem in that unnecessary information maybe provided to the user since the user is forced to read contents bearing no relation to the user's interest.

FIG. 1 is a view illustrating a method of establishing a relationship between users in blogs in the prior art.

Referring to FIG. 1, a user A who is much interested in automobiles, golf, Internet and so on configures automobile, golf, Internet folders and so on in his blog 100. In the mean time, when the user A finds a blog 110 of a user B who has information relevant to automobiles while the user A is surfing the Internet, the user A copies a relevant post and puts it into the automobile folder in his blog 100, or links his blog 100 to the blog 110 of the user B.

In the mean time, the user B configures automobile, movie, cartoon folders and so on in his blog 110 and links his blog 110 to a blog 120 of a user C who is interested in movies, a blog 130 of a user D who is interested in automobiles, and a blog 140 of a user E who is interested in cartoons.

Under such circumstances, however, the blog 110 of the user B has only a list of neighboring blogers of the user B, that is, the user C, user D, and user E, but can not obtain information on what the user B bears a neighborhood relationship with the user C, the user D and the user E for. Accordingly, it is inconvenient for the user A to directly confirm all of the blogs of the users C, D and E in order to meet the user D who is interested in automobiles through the user B. This means that the user B makes no contribution to extension of a relationship (information) with the user B.

In addition, some portal sites provide means such as an RSS reader in order to further facilitate information collection of blogs. The RSS, which is an abbreviation of ‘Really Simple Syndication’ or ‘Rich Site Summary’, means a format to implement an XML (Extensible Markup Language). Using the RSS, it is possible to syndicate blog contents without difficulty or subscribe to contents of other blogs. In addition, if RSS addresses of other blogs are registered in a program through the RSS reader, contents updated in a blog may be conveniently viewed through the RSS reader.

However, when updated information of the user B is delivered to the user A for reinforcement of interaction between the user A and the user B, not only information on automobiles but also information on movies and cartoons are delivered to the user A. Accordingly, the information on movies and cartoons of the user B in which the user A has little interest acts as noises to a network between the user A and the user B, which may result in weakening of interaction therebetween.

In the end, as described above, even if effective contents collection means such as the RSS reader is provided, when a certain user collects information through the interconnection between blogs with an owner of a concerned blog as the central figure, there arises a problem in that unnecessary contents in which the user has little interest are also collected.

### SUMMARY OF THE INVENTION

It is therefore an object of the present invention to provide an apparatus and method for interlinking topical classified objects having properties allowing effective interaction between users by giving property of state and behavior to an existing classification system, such as folders of blogs having only a simple identification function, and a computer readable medium for processing the method.

It is another object of the present invention to provide an apparatus and method for interlinking topical classified objects having properties allowing effective collection of contents required for users by interlinking categories in which the users have interest, and a computer readable medium for processing the method.

It is yet another object of the present invention to provide an apparatus and method for interlinking topical classified objects having properties allowing effective collection of contents required for users by interlinking categories in which the users have interest and informing the users of posts related to interests of the users, and a computer readable medium for processing the method.

To achieve the above objects, according to an aspect, the present invention provides an apparatus for interlinking topical classified objects having properties, including an interest Tong information database for storing one or more object information and one or more post information, which are classified according to interest fields requested by a user through a web server; a buddy information database for storing information on connection between the objects generated by the user and other objects; and an interest Tong service server for providing the user with information on the other objects connected to the objects generated by the user when the user accesses the interest Tong service server.

According to another aspect, the present invention provides a method for interlinking topical classified objects having properties, including the steps of inputting object information from a user and generating objects classified according to the user's interest field; generating posts in the generated objects; and informing objects of different users, which are connected to the objects generated by the user, of a change of the generated objects.

According to yet another aspect, the present invention provides a method for interlinking topical classified objects having properties, including the steps of generating objects classified according to a user's interest field; when the user visits neighboring objects and the visited neighboring objects are classified to have the same or similar interest field as the objects generated by the user, establishing connection between the generated objects and the neighboring objects; generating a link between the generated objects and the neighboring objects according to the connection establishment; and, when there occurs a change in the connected neighboring objects, informing the generated objects of the change in the connected neighboring objects.

The information on interlinking between topical classified object may be stored in a server computer readable record medium. The record medium includes all kinds of record medium in which programs and data are stored so that they can be read by a computer system. For example, the record medium may include a ROM (Read Only Memory), a RAM (Random Access Memory), a CD (Compact Disk), a DVD (Digital Video Disk)-ROM, a magnetic tape, a floppy disk, an optical data storage, etc., and may be implemented with the form of carrier waves (for example, transmission through the Internet). In addition, the record medium may be distributed in computer systems interconnected by a network so that computer readable codes can be stored and executed in a distributed processing system.

While the conventional blogs provide only interconnection between users, thus leading to inefficient information interchange between the users, the present invention allows establishment of more efficient relationship between users by setting an object (for example, a folder, a directory or a category), which is classified by each user, as a connection unit.

### BRIEF DESCRIPTION OF THE DRAWING

FIG. 1 is a view illustrating a method of establishing a relationship between users in blogs in the prior art.

FIG. 2 is a view illustrating a method of establishing a relationship between folders of users in blogs according to an embodiment of the present invention.

FIG. 3 is a view illustrating a system for interlinking topical classified Tongs having properties of objects according to an embodiment of the present invention.

FIG. 4 is a view illustrating a detailed configuration of a Tong service apparatus according to an embodiment of the present invention.

FIG. 5 is a view illustrating a concept of interconnection between post classified Tongs having properties of objects according to an embodiment of the present invention.

FIG. 6 is a view illustrating a function of each process according to an embodiment of the present invention.

FIG. 7 is a view illustrating types of services provided through a Tong service according to an embodiment of the present invention.

FIG. 8 is a flow chart illustrating a service procedure progressed in the side of a user whose Tong is connected to Tongs of other users by other users according to an embodiment of the present invention.

FIG. 9 is a flow chart illustrating a service procedure progressed in the side of a user who connects his Tong to Tongs of other users according to an embodiment of the present invention.

FIG. 10 is a view illustrating configuration of a system for generating Tongs according to an embodiment of the present invention.

FIG. 11 is a signal flow diagram illustrating a Tong generation procedure according to an embodiment of the present invention.

FIG. 12 is a signal flow diagram illustrating a connection Tong addition procedure according to an embodiment of the present invention.

FIG. 13 is a signal flow diagram illustrating an information provision procedure of an interest Tong according to an embodiment of the present invention.

FIG. 14 is a signal flow diagram illustrating a Tong surfing procedure according to an embodiment of the present invention.

FIG. 15 is a block diagram illustrating a detailed function of a notification server according to an embodiment of the present invention.

FIG. 16 is a block diagram illustrating a detailed function of a notification management server according to an embodiment of the present invention.

FIG. 17 is a view showing a webpage screen on which Tong generation menus are configured according to an embodiment of the present invention.

FIG. 18 is a view showing a webpage screen on which a main menu of My Tong is configured according to an embodiment of the present invention.

FIG. 19 is a view showing a webpage screen notifying a change occurring in a first-kinship Tong according to an embodiment of the present invention.

FIG. 20 is a view showing a webpage screen of a Tong informer notifying a change occurring in a first-kinship Tong according to an embodiment of the present invention.

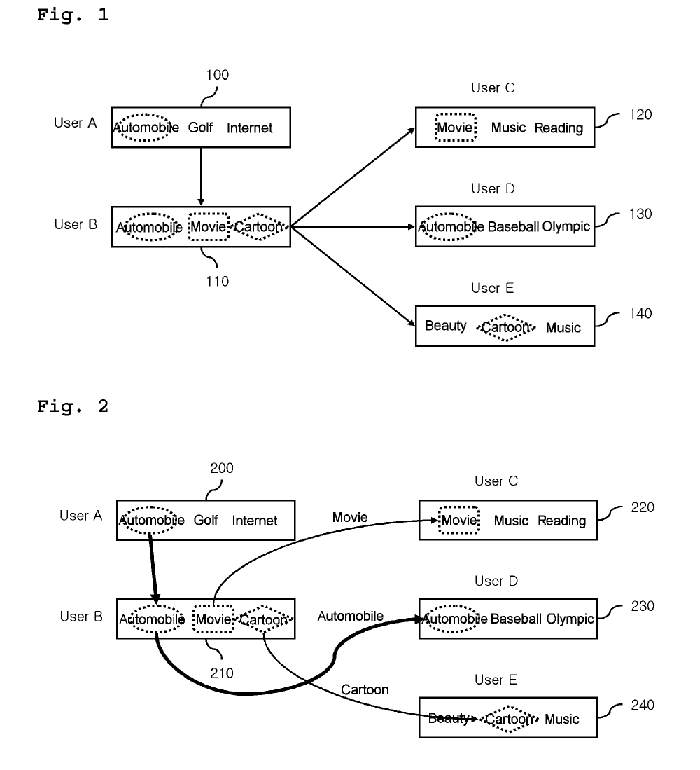

### BEST MODE FOR CARRYING OUT THE INVENTION

In the present invention, a unit, ‘Tong’, as an object having property of state and behavior is introduced, unlike an existing classification system having property of identity. The ‘Tong’ is a concept similar to a folder or a directory of a blog and is a classification unit classified according to interest of users. Accordingly, the present invention is also applicable to folders and directories introduced into the conventional blogs, and, preferably, is implemented by introducing the concept of Tong configured by the classification unit classified according to interest of the users.

That is, when a user classifies individual posts according to a subject selected and decided by him or his interest, each Tong can have its own state and take a behavior as it is influenced by activities of users and visitors. The present invention proposes a system and method for facilitating collection, storage and management of information of users and formation of a network by configuring a variety of menus using developed factors corresponding to the properties.

In a system of the present invention, the Tong has the following technical features and functions as the object.

1) Tongs in a service assume images of titles, categories, representatives and the like according to interest of the users and can be easily utilized through search for each field.

2) Each Tong has information on the generation date, the number of materials, the number of classification, the number of reputation scraps, the number of connected Tongs, the number of connected blogs, etc., by Tong owners, visitors and the connected Tongs, and represents them in various ways.

3) When a user registers a different user's Tong decided to have a relation with the user as a connection Tong (or first-kinship Tong), if there occurs a change in the connection Tong, the user brings contents of the change of the connected Tong to his own space and exposes the contents in the space. In addition, when there occurs a change through an application program, connected Tongs are informed of information on the change in real time.

In addition, terms introduced to implement the present invention are defined as follows.

1) ‘Tong’ has a concept of folder or category in which a user composes his writings or contents are stored through a scrap, and is classified by three steps (large/medium/small) categories.

2) ‘Connection Tong’ refers to a different user's Tong decided to have relation with a user's Tong, which is also called ‘first-kinship Tong’.

Hereinafter, preferred embodiments of the present invention will be described in detail with reference to the accompanying drawings. In the following detailed description of the present invention, concrete description on related functions or constructions will be omitted if it is deemed that the functions and/or constructions may unnecessarily obscure the gist of the present invention.

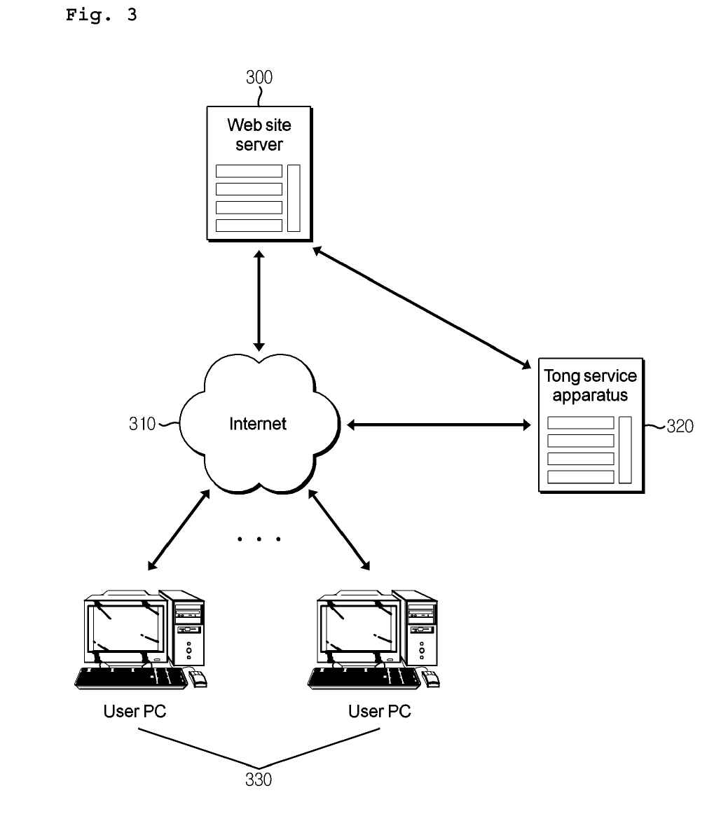

FIG. 2 is a view illustrating a method of establishing a relationship between folders of users in blogs according to an embodiment of the present invention.

Referring to FIG. 2, a blog 200 of a user A is not directly connected to a blog 210 of a user B, but connected to a folder, which has the same interest as the blog 200 of the user A, of folders of the blog 210 of the user B.

For example, when the user A, who is interested in automobiles, golf and Internet, creates folders corresponding to his interest fields in his blog 200 and manages these created folders and the user B, who is interested in automobiles, movies and cartoons, creates folders corresponding to his interest fields in his blog 210 and manages these created folders, the user A does not connect his blog 200 to the blog 210 of the user B, but connects the automobile folder in his blog 200 to the automobile folder in the blog 210 of the user B. By doing so, an information-centered network not a user-centered network is established. In this case, in the present invention, as described above, an object having the concept of the folder classified for each interest field is referred to as ‘Tong’.

In the meantime, the user B connects his folders (automobile, movie and cartoon folders) to folders of other users having the same or similar interest fields as the user B, respectively. For example, the automobile folder of the blog 210 of the user B is connected to an automobile folder of a blog 230 of a user D, the movie folder of the blog 210 of the user B is connected to a movie folder of a blog 220 of a user C, and the cartoon folder of the blog 210 of the user B is connected to a cartoon folder of a blog 240 of a user E.

In this case, a connection folder list is provided for each folder on the blog 210 of the user B, and, according to the provided connection folder list, when the user A visits the automobile folder of the blog 210 of the user B, the user A may easily find the automobile folder of the blog 230 of the user B connected to the automobile folder of the blog 210 of the user B.

In addition, considering the above-mentioned connection process from the side of interaction, the user A is informed of only information related to a change in automobiles in the blog 210 of the user B, but not informed of information related to a change in movies or cartoons of the user B in which the user A is not interested, thus avoiding a problem of noises occurring in the user-centered network as mentioned above.

FIG. 2 shows an example to which the present invention is applied with the connection between the folders of the blogs for the purpose of assisting an understanding of the present invention. Hereinafter, the concept of Tong configured by a classification unit according to the interest fields of the users as mentioned above will be introduced and described. In addition, it is apparent that various functions of Tongs in the following description may be also applied to folders or directories created in the conventional blogs.

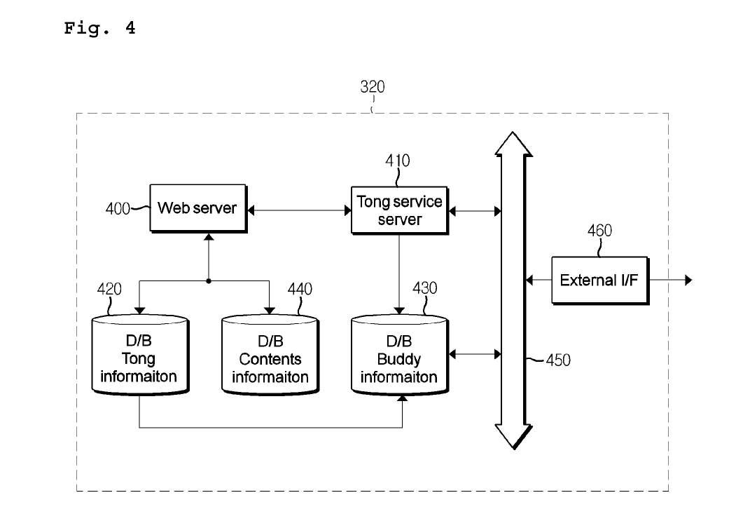

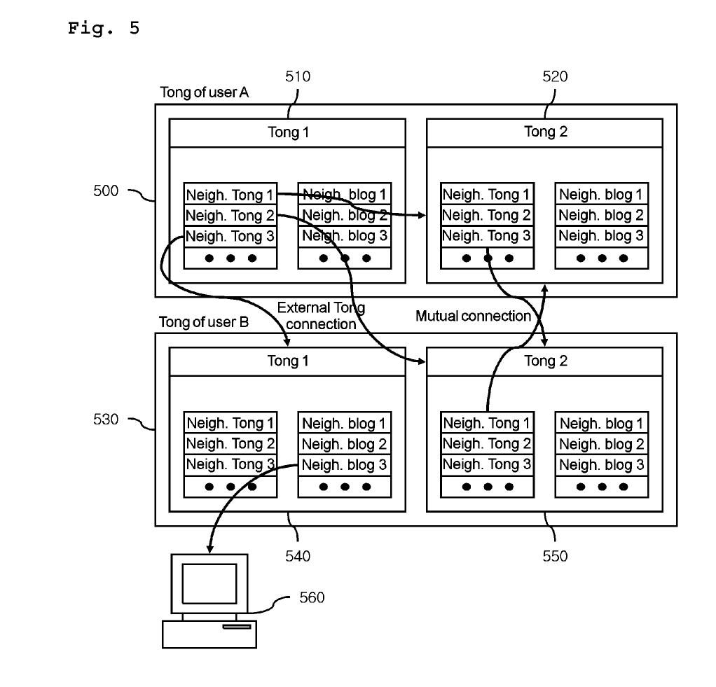

Now, a system and apparatus for implementing the present invention will be described with reference to FIGS. 3 and 4.

FIG. 3 is a view illustrating a system for interlinking topical classified objects having properties according to an embodiment of the present invention. Referring to FIG. 3, a system according to an embodiment of the present invention may include a web site server 300, Internet 310, a Tong service apparatus 320, and one or more user computer terminals 330, etc.

A user accesses the web site server 300 through the user computer terminal 330 interlinked to the Internet 310. In this case, the web site server 300, which is a host system, means a server that provides web pages of a relevant web site to the user computer terminal 330. For example, the web site server 300 is a server that provides a portal site providing blog functions on the Internet. That is, the web site server 300 functions as an information provider for providing information to the user computer terminal 330 through a homepage.

The Tong service apparatus 320 is an apparatus that provides Tongs as objects having the concept similar to the folders of the blogs for each user according to the present invention. The Tong service apparatus 320 may generate one or more Tongs according to interest fields for each user and generate connection between users in the unit of Tong according to the interest fields for each user.

That is, the users collect various kinds of information from the web site server 300 through their computer terminals 330, classify the collected information according to the interest fields of the users, and include the classified information in Tongs generated through the Tong service apparatus 320. In addition, instead of establishing connection between blogs of the users, by establishing connection between Tongs generated by the users having the concept of folders created according to the interest fields of the users, as described above, only a change of posts for the interest fields of the users can be effectively known.

In the mean time, each user can generate one or more Tongs for each interest field. In the present invention, a set of Tongs generated by each user is defined as ‘My Tong’. In this case, the My Tong defined above may be understood as a concept similar to the conventional blogs containing one or more blogs. Accordingly, one My Tong is provided to each user in order to implement the present invention and one or more Tongs are generated and managed in the My Tong according to the interest field of the user.

FIG. 4 is a view illustrating a detailed configuration of the Tong service apparatus 320 according to an embodiment of the present invention.

Referring to FIG. 4, the Tong service apparatus 329 according to an embodiment of the present invention may include a web server 400, a Tong service server 410, a Tong information database 420, a buddy information database 430, a contents information database 440, a general-purpose communication bus 450, an external interface 460, etc.

Processing data through the Tong service apparatus 320 may be generally divided into two functions. One of the two functions is provision of a ‘connection Tong update’ menu on a service and another is notification through a remote controller.

The connection Tong update menu may be implemented using database query. That is, based on an identifier of a Tong connected by a particular user, a change in the Tong is displayed on a web page. To this end, it is preferable to record changes of all Tongs in a database. In the mean time, from the point of view of implementation, a data flow may be opposite to the above-mentioned data flow. First, individual Tongs record their change in a database irrespective of whether or not they are registered as neighboring Tongs, and a particular Tong that registers a different Tong as a neighboring Tong simply fetches and shows a change of the different Tong.

Second, the form of Push is used. That is, when an ‘informer’ as information means is displayed on a user's desktop computer, a separate informer server informs the informer of change of all Tongs of the user. In this case, the data flow may be again considered from two sides. A first side is a notification server to which an informer client is connected. When the informer client accesses the notification server, the notification server authenticates a user of the informer client, fetches information on a connection Tong of the user, and copies the fetched information into a notification server-only database.

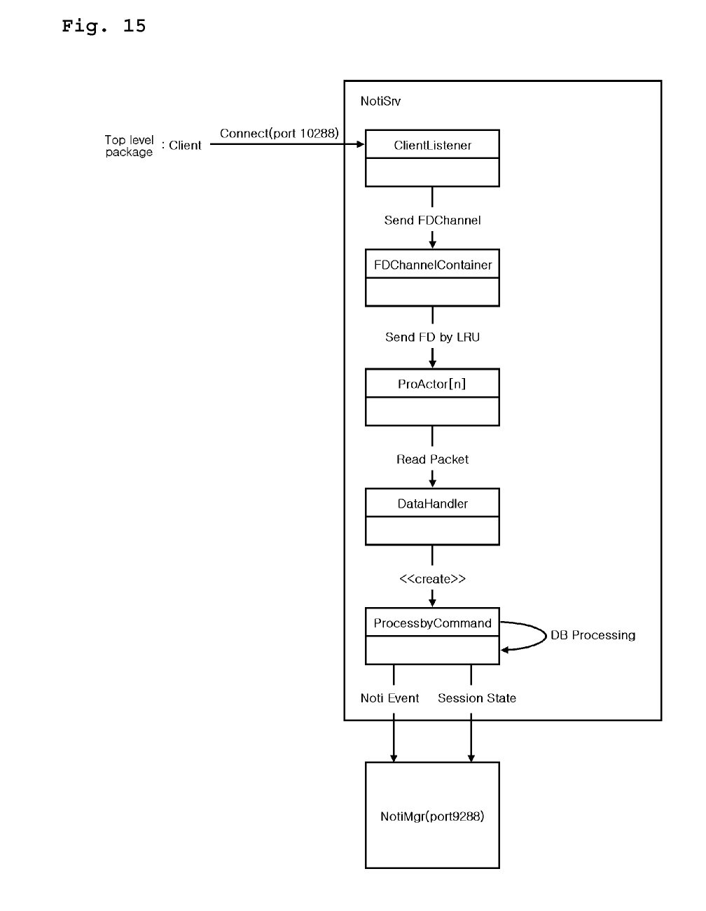

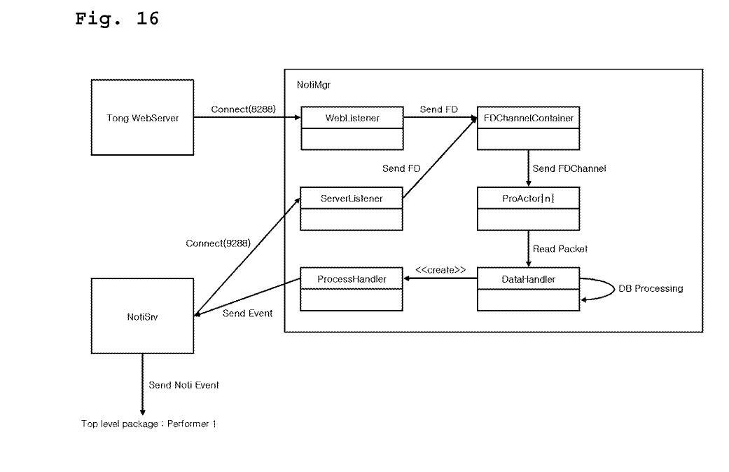

A second side is a notification logic server that receives a change of Tongs from the web server 400. If the notification logic server determines that the change is information to be sent to a user who currently accesses the notification logic server, the notification logic server instructs the notification server to send notification information to the user who accessed the notification server. At this time, the determination is made with reference to a notification-only database copied by the notification server. The web server 400 sends all changes to the notification logic server with no determination to send a notification. A detailed Tong information provision procedure through the notification server will be described with reference to FIGS. 15 and 16. More specifically, referring to FIG. 4, the user accesses a Tong service provision system (that is, the Tong service apparatus) through the web server 400 of the Tong service apparatus 320 and receives a service of generating and managing Tongs in which the user is interested from the Tong service server 410. In the mean time, information on Tongs generated by the user is stored in the Tong information database 420. In addition, contents information (for example, posting information) of Tongs generated by each user is stored in the contents information database 440.

At this time, when a particular user accesses and logs in the Tong service apparatus 320 through the external interface 460 and the general-purpose communication bus 350, information on posting change of Tongs connected to the Tongs generated by the user (i.e., connection Tongs) is provided to the user. That is, when the Tong service server 410 confirms the access of the particular user, it fetches information on connection Tongs of the user from the Tong information database 420 and copies the fetched information into the buddy information database 430.

The web server 400 provides all changes occurring in Tongs of all users to the Tong service server 410, and the Tong service server 410 determines whether or not the changes are information to be sent to user who currently access the web server 400 with reference to the information on the connection Tongs copied into the buddy information database 430.

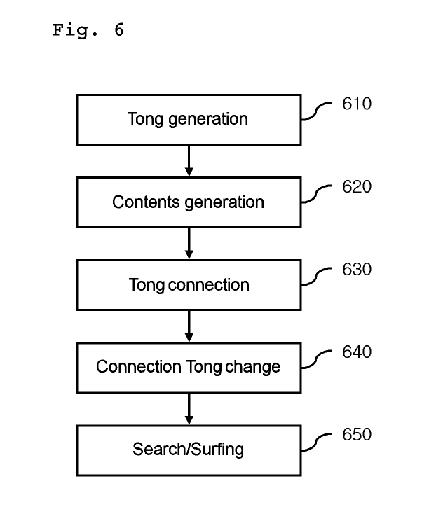

FIG. 5 is a view illustrating a concept of interconnection between post classified Tongs having properties of objects according to an embodiment of the present invention.

Referring to FIG. 5, one Tong system (i.e., My Tong) is provided to each user in order to implement the present invention. That is, My Tongs 500 and 530 are provided to users A and B, respectively. In this case, one or more Tongs may be generated in each My Tong according to interest fields of the users. For example, the user A generates Tong 1 (510) and Tong 2 (520) in the My Tong 500 according to his interest field and the user B generates Tong 1 (540) and Tong 2 (550) in the My Tong 530 according to his interest field. At this time, the Tong 1 (510) of the user A may be generated as a Tong having an interest field of automobiles and the Tong 2 (520) of the user A may be generated as a Tong having an interest field of golf. On the other hand, the Tong 1 (540) of the user B may be generated as a Tong having an interest field of automobiles and the Tong 2 (520) of the user B may be generated as a Tong having an interest field of movies.

In the meantime, the Tongs as described above may be understood as an extended concept of blogs and folders. That is, the Tongs area classification unit for classifying information (i.e., post) collected or created according to the interest fields of the users. Accordingly, the function of the Tongs according to the present invention is applicable to the conventional blogs and folders (or directories).

A method of interconnecting the Tongs may be implemented in various ways. For example, a connection to a different Tong may be established in the same My Tong (i.e., the same user), or a connection to a Tong, which has the same or similar interest field, contained in a My Tong of a different user may be established. At this time, such a connection may have unidirectionality between a connecting user and a connected user, or may have bidirectionality if a mutual connection between the users is established.

In addition, the Tongs may be connected to the same type of blogs, or may be connected to an external blog 560. For example, the Tongs may be connected to different Tongs in the Tong system according to the present invention or folders of blogs provided from other external portal sites.

FIG. 6 is a view illustrating a function of each process according to an embodiment of the present invention. Referring to FIG. 6, processes performed in the present invention may include processes of Tong generation 610, contents generation 620, Tong connection 630, connection Tong change 640, and search/surfing 650.

First, the Tong generation process 610 may generate new Tongs having certain types of characteristics by inputting a name, representative image, classification category, Tong introduction information of a Tong newly established in a My Tong of a user. In this case, means such as an image editor may be used to generate the representative image of the Tong.

Next, the contents generation process 620 may generate new contents in a Tong of a user generated when the user creates posts directly, uploads photographs, scraps or clips multimedia, or checks sympathy to posts of different users. In this case, local files may be edited by an editor or may be uploaded, and, when contents in Tongs of other users are fetched, a function of store in My Tong maybe utilized. In addition, when contents are fetched from an external web site, a clipping function may be utilized. Activities of users such as the contents generation as mentioned above achieve effects to arouse dynamic activities by rising a level and index of users.

The Tong connection process 630 is a process of connecting a Tong of a particular user to neighboring Tongs or neighboring blogs, as shown in FIG. 5. In this case, neighboring Tongs are added to Tongs of different users, and establishment of connection from an external blog may be implemented through means such as the above-mentioned RSS reader. At this time, functions such as list of collected blogs, estimation of Tongs, detailed information on connection Tongs, and connection tap maybe provided. The Tong connection process achieves an effect of extension of interests through connection to Tongs of other users.

In the connection Tong change process 640, when there occurs a change of contents in a Tong connected by a user, contents of a connection Tong contained in a My Tong of the user are updated, and the change may be notified using an electric sign informer of a remoter controller, which will be described later. Such a connection Tong change notification process allows the change to be effectively perceived by the user. In addition, the search/surfing process 650 may be additionally provided.

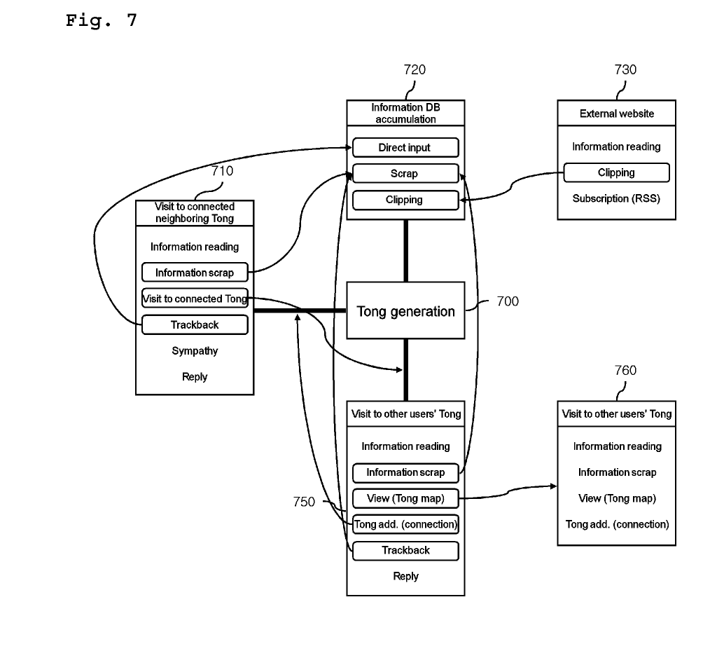

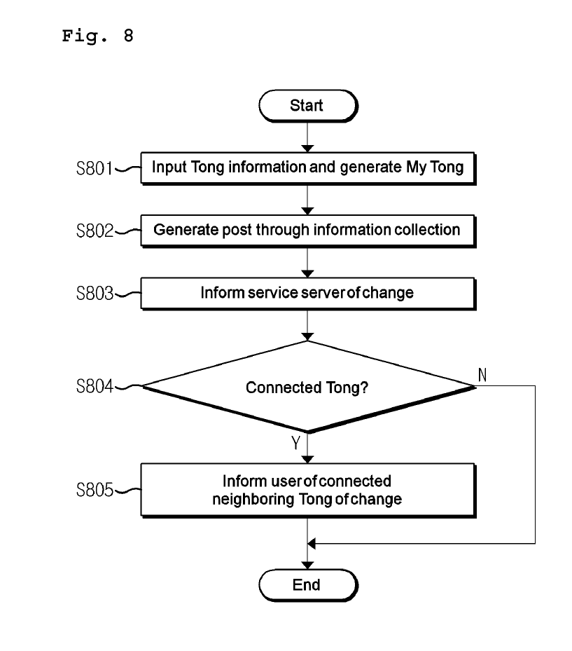

FIG. 7 is a view illustrating types of services provided through a Tong service according to an embodiment of the present invention.

Referring to FIG. 7, a user generates (700) a Tong in his My Tong and may receives various services according to an embodiment of the present invention using the generated Tong.

For example, when a user inputs his writings in his Tong or scraps other user's writings, information may be accumulated (720) in an information database. Further, by clipping writings registered in an external web site (730), information may be accumulated in the information database. In the mean time, a function of reading of information through the external web site or a function of subscription using an RSS reader tool may be performed.

In addition, the user may visit (750) Tongs of other users to read or scraps information of the Tongs or may additionally connect his Tong to the Tongs of other users. In addition, the user visits (760) a Tong of a third party connected to the visited Tongs of other users to perform the same function. Of course, the user may visit (710) a Tong connected to his Tong to perform the same function. As described above, since the connection between the Tongs has a meaning through connection between Tongs having the same or similar interest fields by a selection of the users, the Tong of the third party connected to the Tongs of other users is very likely to be a Tong having the same or similar interest fields as the Tong of the user. Accordingly, by tracing a connection relationship between the Tongs, it is possible to extend an interest network unlimitedly.

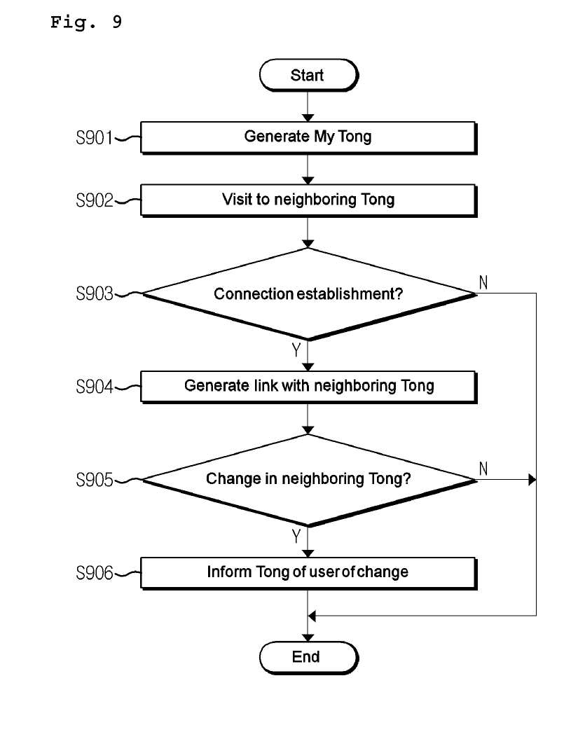

FIG. 8 is a flow chart illustrating a service procedure progressed in the side of a user whose Tong is connected to Tongs of other users by other users according to an embodiment of the present invention.

Referring to FIG. 8, first, a user inputs Tong information and generates Tongs classified according to his interest field (Step S801). Then, posts are created in the generated Tongs through collection or creation of information (Step S802).

At this time, a service server is informed of a change of the Tongs (Step S803). In addition, Tongs of other users connected to a Tong of the user are informed of this change. That is, if there exists a neighboring Tong connected to the Tong of the user changed through the post creation (Step S804), a user of the connection neighboring Tong (connection Tong) is informed of the change (Step S805)

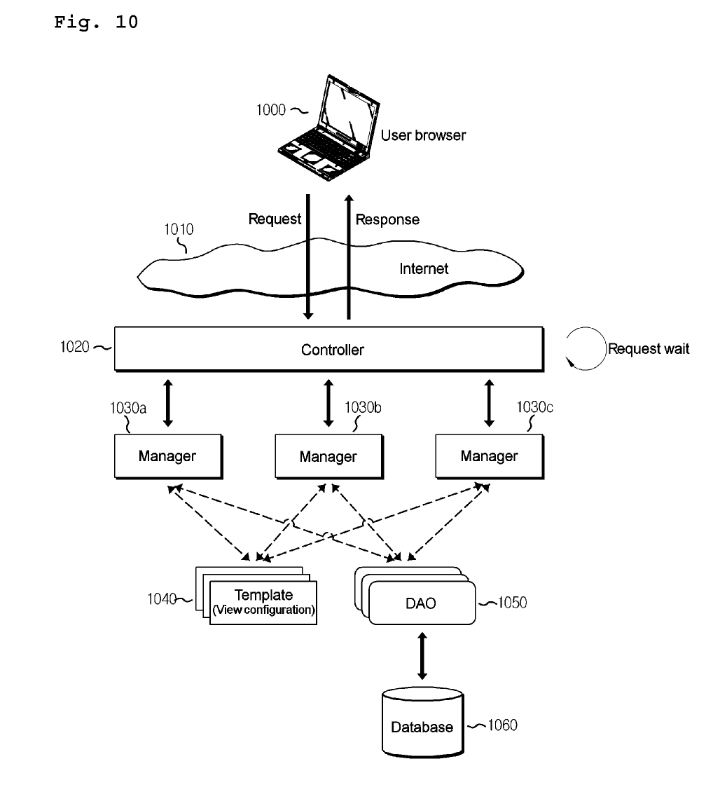

FIG. 9 is a flow chart illustrating a service procedure progressed in the side of a user who connects his Tong to Tongs of other users according to an embodiment of the present invention.

Referring to FIG. 9, first, a user generates Tongs classified according to his interest field in his My Tong (Step S901) and visits a neighboring Tong (Step S902). If the neighboring Tong is classified to have the same or similar interest field as the Tong generated by the user, the user attempts to establish a connection between his Tong and the neighboring Tong (Step S903).

According to the attempt to establish the connection, a link between the Tong of the user and Tongs of other users is generated (Step S904). Then, if there occurs a change in the connected neighboring Tong (Step S905), the user is informed of the change of the connected neighboring Tong (Step S906).

Hereinafter, a method of implementing procedures to generate Tongs and establish connection between the Tongs according to the present invention will be described in more detail with reference to FIGS. 10 to 13. The following description shows only an example of implementation of the present invention. Therefore, it is apparent that the following description may be modified by different methods or tools and is not limited by particular terms or names.

FIG. 10 is a view illustrating configuration of a system for generating Tongs according to an embodiment of the present invention.

Referring to FIG. 10, each user (client) 1000 requests a controller 1020 of the Tong service system to generate Tongs and interconnect the Tongs through the Internet 1010, and a result of process in the Tong service system is transmitted to each user 1000 through the controller 1020.

In the mean time, the Tong service system to provide a related service according to the present invention may include the controller 1020, a manager 1030 for performing one or more function, a template 1040 for constructing a screen, a database 1060 for storing various kinds of data, and a data access object (DAO) 1050 for accessing the database 1060.

The controller 1020 analyzes a request from the user 100, entrusts the manager 1030 with various functions, and sends the user 1000 a process result from the manager 1030. In addition, the manager 1030 takes direct responsibility for various minor functions and performs substantial tasks such as addition and inquiry of a database for a request from the user 1000.

The DAO 1050, which is made by the manager 1030, combines and reflects contents of the physical database 1060 to construct a form of structure adapted to a development language.

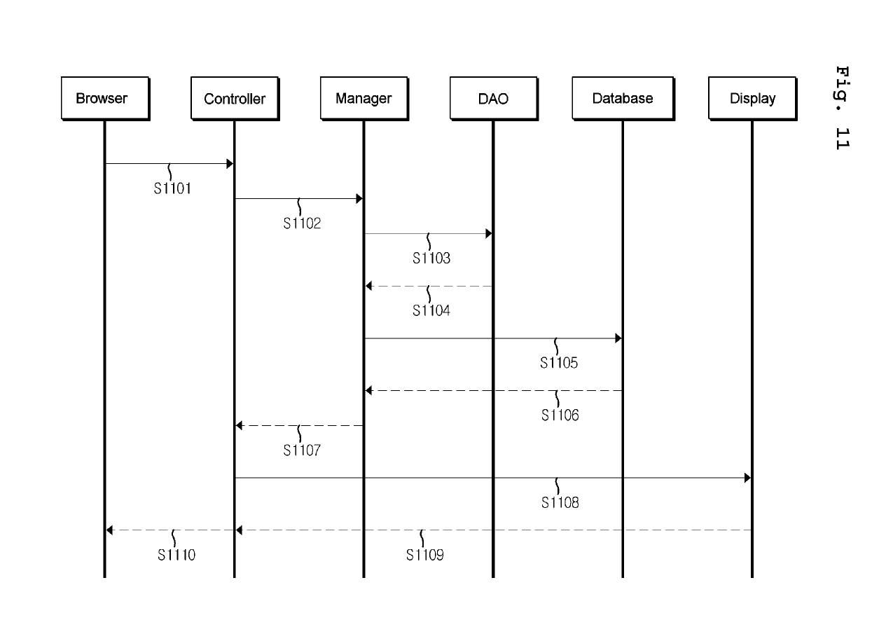

FIG. 11 is a signal flow diagram illustrating a Tong generation procedure according to an embodiment of the present invention.

Referring to FIG. 11, first, when a user requests the controller to generate a new Tong through a browser, the browser transmits a request message to generate the Tong to the controller (Step S1101), and the controller transmits the received Tong generation request message to the manager (Step S1102). The manager make a request for DAO generation to store Tong information (Step S1103), receives the generated DAO, and generates a Tong object by establishing the Tong information (Step S1104). Subsequently, the manager stores the generated Tong object in a database (Step S1105) and receives a unique key (Step S1106). Then, the manager transmits generation state information to the controller (Step S1107) and the controller requests a display unit to construct a resultant page (Step S1108).

Finally, the display unit transmits the resultant page constructed according the request to the controller (Step S1109), and the controller transmits the received resultant page to the browser, thus displaying results of the generated Tong to the user.

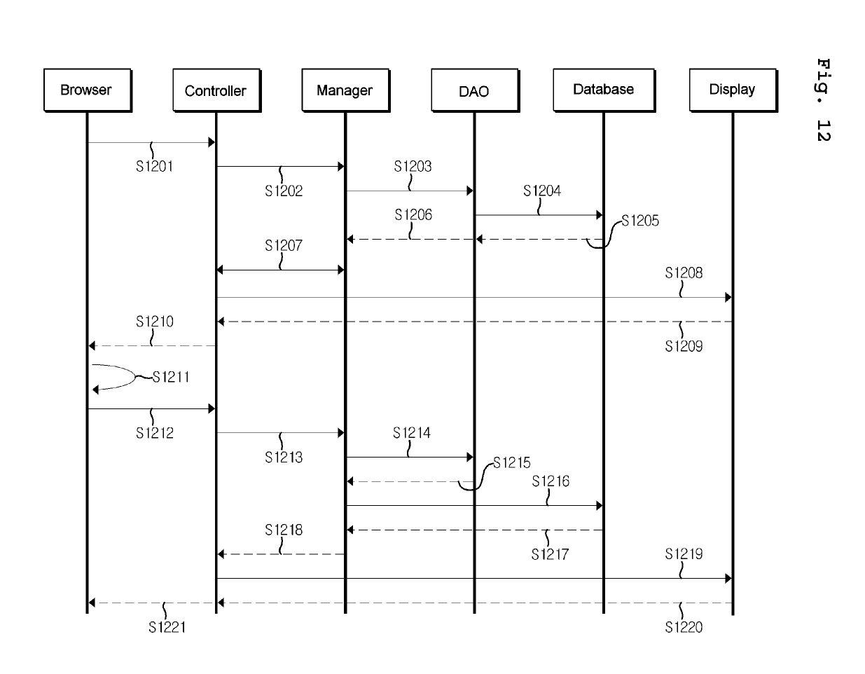

FIG. 12 is a signal flow diagram illustrating a connection Tong addition procedure according to an embodiment of the present invention.

Referring to FIG. 12, first, when a user visits a Tong of a different user and clicks a connection addition button through a browser, the click information is transmitted to the controller (Step S1201), and the controller requests the manager to provide a Tong list of the user to establish a new connection (Step S1202). According to the request, the manager generates DAO to generate the Tong list of the user (Step S1203), and the DAO transmits query to a database to generate contents adapted to an object (Step S1204), stores Tong information of the user (Step S1205), and returns the Tong information to the manager (Step S1206). The manager collects the DAO to construct a list and transmits the constructed list to the controller (Step S1207).

Then, the controller requests a display unit to generate a connection addition information input page (Step S1208). According to the request, the display unit generates the connection addition information input page and transmits a resultant page to the controller (Step S1209). The controller transmits the received resultant page to the browser (Step S1210) and displays the resultant page to the user.

In the mean time, the user specifies a Tong of the user to be connected on the browser (Step S1211) and transmits a connection request message to the controller (Step S1212). The controller transmits a ‘My Tong connection’ request message to the manager (Step S1213). The manger makes a request for DAO generation to generate a directionality relation (Step S1214) and generates a value object (Step S1215). The manager stores values of relation information received from the controller in the database (Step S1216), and receives a unique key value from the database (Step S1217).

Next, the manager transmits a generation state according to the link establishment to the controller (Step S2118), and the controller requests the display unit to generate a connection addition result page (Step S1219). According to the request, the display unit generates the connection addition result page and transmits the result page to the controller (Step S1220) The controller transmits the received result page to the browser 9 Step S1221) and displays the result page to the user.

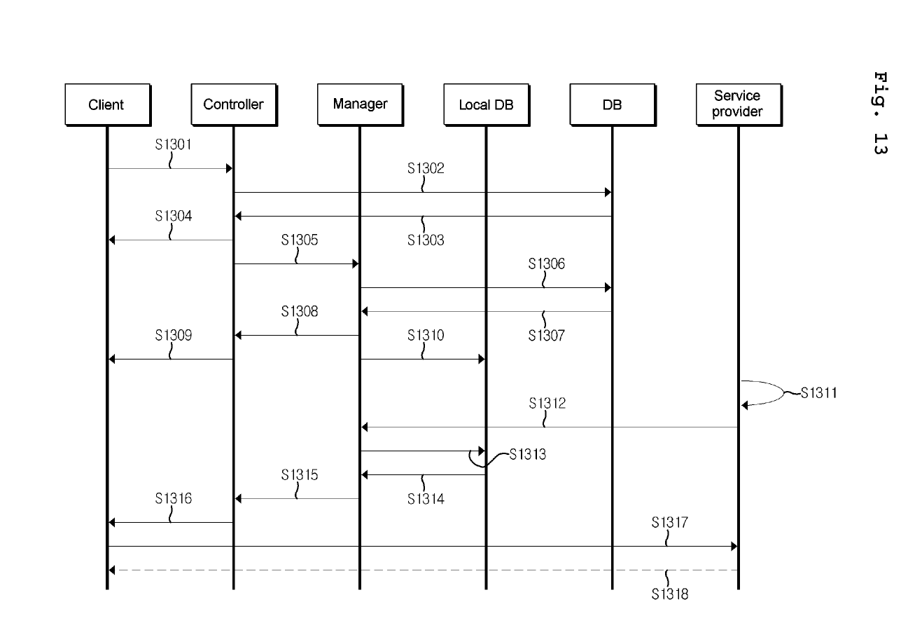

FIG. 13 is a signal flow diagram illustrating an information provision procedure of an interest Tong according to an embodiment of the present invention.

Referring to FIG. 13, first, a client (i.e., user) logs in by inputting an ID and a password in the controller (i.e., a front end server) (Step S1301). When the user logs in, the controller transmits the input user ID to a database (Step S1302) and receives information on the user from the database (Step S1303). At this time, the controller outputs the received user information to the client (Step S1304) and transmits the user ID, which is input from the client, to the manager (i.e., aback end server) (Step S1305).

At this time, the manager requests the database to provide information of an interest Tong (Step S1306) and receives the requested Tong information (Step S1307). Then, the manager transmits the received Tong information to the controller (Step S1308) to provide the Tong information to the client (Step S1309). In addition, the manager stores the received Tong information in a local database (Step S1310).

In the mean time, if an event occurs from a service provider (Step S1311), an ID for the event is transmitted to the manager (Step S1312). The manager requests the local database to search relevant users (Step S1313) and receives relevant user information as a search result from the local database (Step S1314). The manager transmits the received relevant user information and the event information to the controller (Step S1315) and provides a service event to the client (i.e., the user) (Step S1316). Finally, the client requests the service provider to provide a service view (Step S1317) and receives the event information from the service provider (Step S1318).

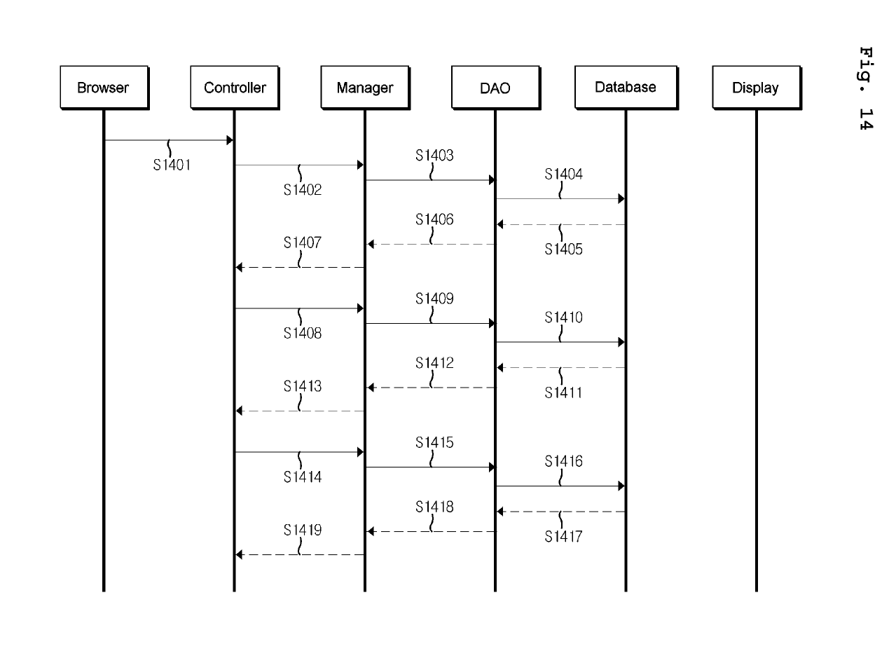

FIG. 14 is a signal flow diagram illustrating a Tong surfing procedure according to an embodiment of the present invention.

Referring to FIG. 14, when a user selects any Tong to perform a Tong surfing, the system provides a list of Tongs (i.e., first-kinship Tongs) connected to the selected Tong. In addition, by selecting one of the connected Tongs, a list of different Tongs connected to the Tong may be provided. By doing so, each user can find information on his interest field effectively and successively.

First, when the user (client) requests the controller to perform the Tong surfing (Step S1401), the controller requests the manager to provide information on a selected Tong (Step S1402). According to the request, the manager requests the DAO to provide the information on the selected tong (Step S1403). The DAO requests (Step S1404) a database to provide data (Step S1405). The provided data are transmitted from the DAO to the controller through the manager (Steps S1406 and S1407).

Next, after obtaining the information on the selected Tong, the controller requests the manager to provide a list of Tongs that enter into a first-kinship relation with the selected Tong (Step S1408). According to the request, the manager requests the DAO to provide information on the requested list (Step S1409). The DAO requests (Step S1410) the database to provide data (Step S1411). The provided data are transmitted from the DAO to the controller through the manager (Steps S1412 and S1413).

In addition, the controller requests the manager to provide not only the list of Tongs that enter into the first-kinship relation with the selected Tong but also a list of Tongs with which the selected Tong enters into a first-kinship relation (Step S1414). At this time, the manager requests the DAO to provide the information on the requested lists in a way similar to the above-described way (Step S1415) The DAO requests (Step S1416) the database to provide data (Step S1417). The provided data are transmitted from the DAO to the controller through the manager (Steps S1418 and S1419).

By doing so, each user can find information on his interest field easily through a relationship between a Tong generated according to an interest field of a user and Tongs connected to the Tong of the user according to the same interest fields of other users.

For example, when a user selects any Tong A and clicks a Tong surfing button, information on the Tong A (for example, a Tong title, description, images, etc) is fetched, as described above, and, in addition, a list of Tongs that enter into a first-kinship relation with the Tong A and a list of Tongs with which the Tong A enters into a first-kinship relation are fetched.

At this time, the list of Tongs that enter into the first-kinship relation with the Tong A can be obtained by fetching a list in which an object identifier connected in a first-kinship Tong connection information table is a unique identifier of the Tong A. In addition, the list of Tongs with which the Tong A enters into the first-kinship relation can be obtained by fetching a list in which a subject identifier connected in a first-kinship Tong connection information table is a unique identifier of the Tong A.

In the mean time, the fetched lists may be combined by a user interface through means such as graphics and may be displayed on a pop-up browser window. At this time, a list of Tongs that enter into a first-kinship relation with a particular Tong and a list of Tongs with which a particular Tong enters into a first-kinship relation may be separated from each other by means of such as an IFRAME. Accordingly, a page movement in each frame is possible. For example, the list of Tongs that enter into the first-kinship relation with the Tong A may be displayed in the left portion of a screen and the list of Tongs with which the Tong A enters into the first-kinship relation may be displayed in the right portion of the screen.

In this case, when a user selects and clicks a particular Tong in the lists displayed on the screen, a list of Tongs that enter into a first-kinship relation with the clicked Tong and a list of Tongs with which the clicked Tong enters into a first-kinship relation, with the clicked Tong as a center, may be provided. In addition, when a user clicks a shortcut in a particular Tong, a page may be moved to a main page of the particular Tong.

So far, the Tong generation and addition and the Tong surfing procedure according to the present invention have been described. Hereinafter, a method of notifying a change of Tongs through the notification server according to an embodiment of the present invention will be described with reference to FIGS. 15 and 16.

FIG. 15 is a block diagram illustrating a detailed function of a notification server according to an embodiment of the present invention.

Referring to FIG. 15 showing a diagram of the notification server connected to a client, connection information of the client is transmitted from the notification server to a back end server (i.e., a notification manager; NotiMgr) and required user information is fetched from a database.

First, when the client accesses the notification server, ‘ClientListener’ of the notification server creates a session class for the client and transfers a FD channel instance having a session ID connected to ‘FDchannelContainer’. The ‘FDchannelContainer’ transfers the received FD to a ‘ProActor’ whenever the ‘ProActor’ makes a request for the FD. The ‘ProActor’ is a FD manager and plays a role in FD registration and deletion. In the present invention, n ‘ProActor’s are operated in parallel.

In the mean time, a ‘DataHandler’ analyzes data read from the ‘ProActor’ according to a protocol and creates objects for processing the protocol. Then, a ‘ProcessbyCommand’ inquires a database, transmits data to the notification manager (NotiMgr), or transmits data to the client while processing packets according to the protocol.

FIG. 16 is a block diagram illustrating a detailed function of the notification manager according to an embodiment of the present invention.

Referring to FIG. 16, the notification manager (NotiMgr) receives an notification event of a Tong service and transmits the notification event to the notification server connected to the client to which the notification event is to be transmitted.

That is, when a notification event (for example, addition of a visitors' book) occurs from a Tong web server to a user, the event is transmitted to the notification manager. The notification manager is notified of the event from the Tong web server, processes the FD in the same way as in the notification server, and transmits the event to the notification server. At this time, the notification server notifies the client of a result of the event.

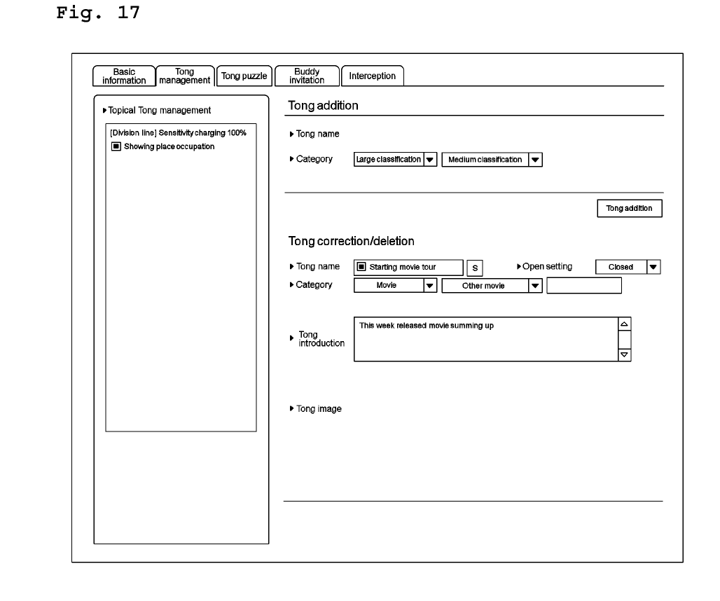

Hereinafter, for the purpose of assisting an understanding of the present invention, a webpage screen on which the Tong service according to the embodiment of the present invention is realized will be described with reference to FIGS. 17 to 20.

FIG. 17 is a view showing a webpage screen on which Tong generation menus are configured according to an embodiment of the present invention.

Referring to FIG. 17, after each user generates his My Tong, he may generate Tongs according to his interest field. That is, each user may write names of the Tongs and select a category for each interest field. In addition, each user may attach introduction writings for the Tongs and a representative image. By doing so, the users may easily grasp interest fields and contents of the Tongs through a main screen of the generated Tongs.

The Tongs may perform a folder function of blogs, as described above. Accordingly, the users who generated the Tongs may insert various writings or photographs in the Tongs. In addition, according to the present invention, each Tong may enter into a connection relationship with Tongs having the same or similar interest fields of different users. In addition, according to the connection relationship, each user may be automatically notified of a change (for example, insertion of new writings) occurring in the connected Tongs of the different users.

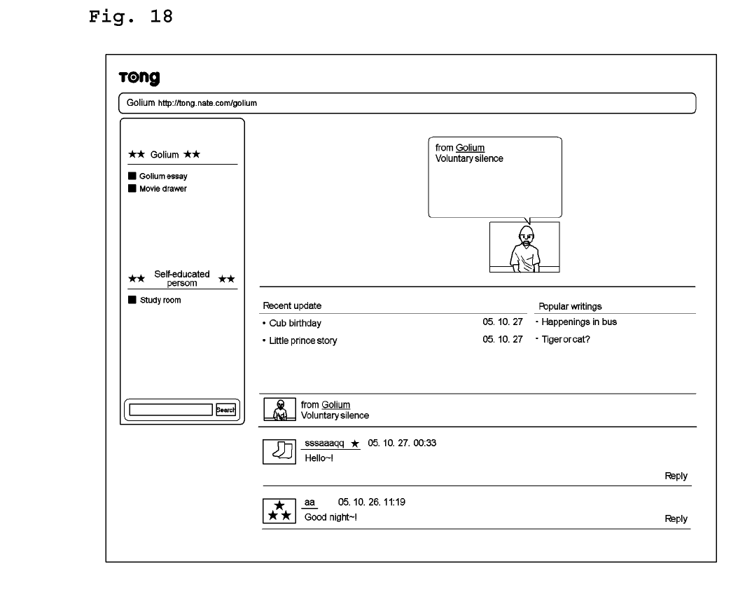

FIG. 18 is a view showing a webpage screen on which a main menu of My Tong is configured according to an embodiment of the present invention.

When Tongs are generated by the method shown in FIG. 17, a My Tong main menu may be generated as shown in FIG. 18. For example, a list of Tongs generated by a user may be classified by category and displayed in a left menu, and the list of Tongs maybe converted to a Tong menu when a Tong is selected. In addition, by notifying each user of events occurring in his My Tong or first-kinship Tongs, new writings related to his interest field may be grasped clearly at a glance.

FIG. 19 is a view showing a webpage screen notifying a change occurring in a first-kinship Tong according to an embodiment of the present invention.

Referring to FIG. 19, when a user connects his Tong to Tongs of different users having the same or similar interest field as first-kinship Tongs, he may be notified of a change of the first-kinship Tongs in real time. That is, when writings or photographs are registered in the first-kinship Tongs, the user may grasp the registered writings or photographs in his Tong in real time through first-kinship Tong news. By doing so, the user may easily obtain information in real time without directly visiting connection Tongs every time and confirming whether or not new writings are registered.

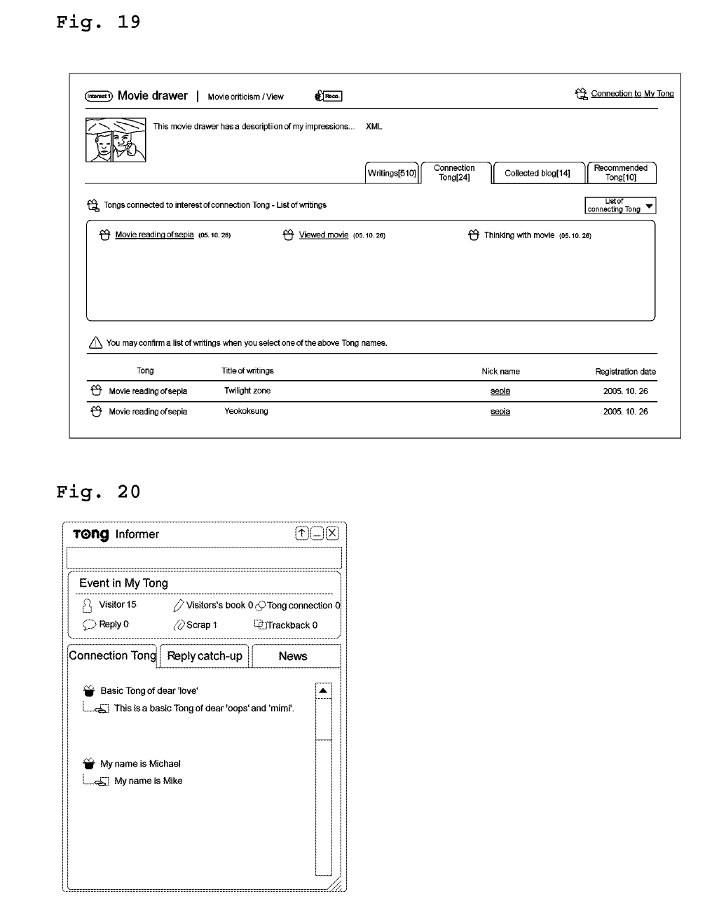

FIG. 20 is a view showing a webpage screen of a Tong informer notifying a change occurring in a first-kinship Tong according to an embodiment of the present invention.

The change of the first-kinship Tongs maybe notified as shown in FIG. 18, and may be notified in real time using a new pop-up window installed in a personal computer, as shown IN FIG. 20. That is, when an informer pop-up window as shown in FIG. 20 is installed in a computer of a user and the user logs in, the user may be notified of the change of the first-kinship Tongs connected by the user in real time through the informer pop-up window. By doing so, the user may confirm newly registered writings for his interest field effectively.

### INDUSTRIAL APPLICABILITY

According to the present invention, as post creators or folder owners connect information collected by them to information collected by other users, it is possible to form an information-centered network and extend this network through interchange of information. Particularly, there is a merit in that a lasting interaction by connection between users is possible through the informer function of information on real-time update change, without fugitive collection of information of other users, and unnecessary visit and search costs may be greatly reduced. In addition, there is an advantage in that items of representative photographs and interest puzzles may be effectively represented, showing users' personality, by using a visual image for interest fields and activities of the users.

In the mean time, when a third user finds only one post and folder related to his interest field, he may move to a connected folder in order to easily obtain information built up by many users for one interest field without performing are-search. In addition, it is possible to over come a problem of repeated exposure of contents spread through simple reproduction in existing search services, which may result in more efficient search. In addition, it is possible to visually and easily grasp such a connection state through a Top map. In addition, it is possible to greatly reduce costs for judgment and selection of information in that level and grade classification through activities for each Tong is suggested.

Lastly, interaction between service providers by the medium of information and interest fields are activated, a close relationship between users may be established, thus activating a re-visit, and service use motive and degree of absorption in service may be further reinforced.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

1. An apparatus for interlinking topical classified objects having properties, comprising:
an interest Tong information database for storing one or more object information and one or more post information, which are classified according to interest fields requested by a user through a web server;
a buddy information database for storing information on connection between the objects generated by the user and other objects; and
an interest Tong service server for providing the user with information on the other objects connected to the objects generated by the user when the user accesses the interest Tong service server.

2. The apparatus according to claim 1, wherein the generated objects are folders classified and constructed for each interest field of the user in a blog of the user.

3. The apparatus according to claim 1, wherein the information on connection between the objects generated by the user and other objects has directionality.

4. The apparatus according to claim 1, wherein other objects connected to the generated objects are objects included in a blog of the same user.

5. The apparatus according to claim 1, wherein other objects connected to the generated objects are objects included in a blog of a different user.

6. The apparatus according to claim 1, wherein other objects connected to the generated objects are folders included in external blogs of other users.

7. A method for interlinking topical classified objects having properties, comprising the steps of:
inputting object information from a user and generating objects classified according to the user's interest field;
generating posts in the generated objects; and
informing objects of different users, which are connected to the objects generated by the user, of a change of the generated objects.

8. The method according to claim 7, wherein the generated objects are folders classified and constructed for each interest field of the user in a blog of the user.

9. The method according to claim 7, wherein information on connection between the objects generated by the user and the objects of the different users has directionality.

10. The method according to claim 7, wherein other objects connected to the generated objects are objects included in a blog of the same user.

11. The method according to claim 7, wherein other objects connected to the generated objects are objects included in a blog of a different user.

12. The method according to claim 7, wherein other objects connected to the generated objects are folders included in external blogs of other users.

13. A method for interlinking topical classified objects having properties, comprising the steps of:
generating objects classified according to a user's interest field;
when the user visits neighboring objects and the visited neighboring objects are classified to have the same or similar interest field as the objects generated by the user, establishing connection between the generated objects and the neighboring objects;
generating a link between the generated objects and the neighboring objects according to the connection establishment; and
when there occurs a change in the connected neighboring objects, informing the generated objects of the change in the connected neighboring objects.

14. The method according to claim 13, wherein the generated objects are folders classified and constructed for each interest field of the user in a blog of the user.

15. The method according to claim 13, wherein information on connection between the generated objects and the neighboring objects has directionality.

16. The method according to claim 13, wherein other objects connected to the generated objects are objects included in a blog of the same user.

17. The method according to claim 13, wherein other objects connected to the generated objects are objects included in a blog of a different user.

18. The method according to claim 13, wherein other objects connected to the generated objects are folders included in external blogs of other users.

19. A computer readable record medium containing a program for performing the method according to claim 7.

20. A computer readable record medium containing a program for performing the method according to claim 13.
